(19) United States
(12) Patent Application Publication
(10) Pub. No.: US 2026/0302053 A1
(43) Pub. Date: Oct. 1, 2026

(54) INDUCTOR AND DC-DC CONVERTER

(71) Applicant: TDK Corporation, Tokyo (JP)

(72) Inventors: Hajime KUWAJIMA, Tokyo (JP); Tomofumi KURODA, Tokyo (JP)

(73) Assignee: TDK Corporation, Tokyo (JP)

(21) Appl. No.: 19/576,136

(22) Filed: Mar. 24, 2026

(30) Foreign Application Priority Data
Mar. 26, 2025 (JP) 2025-051437

(51) Int. Cl. H01F 27/29

(52) U.S. Cl. CPC H01F 27/292

(57) ABSTRACT

An inductor includes an element body formed by including a resin, a coil conductor disposed in the element body, and a terminal connected to the coil conductor, the terminal being exposed from a surface on one side in a first direction of the element body. The terminal has a first region located outside the element body when viewed from the first direction, and a second region provided at a position overlapping with the element body. A first width of a portion exposed in the first region is wider than a second width of a portion exposed in the second region when viewed from the first direction.

### CROSS-REFERENCE TO RELATED APPLICATIONS

This application is based upon and claims the benefit of priority from Japanese Patent Application No. 2025-051437, filed on Mar. 26, 2025, the entire content of which is incorporated herein by reference.

### TECHNICAL FIELD

The present disclosure relates to an inductor and a DC-DC converter.

### BACKGROUND

Japanese Unexamined Patent Publication No. 2023-19829 discloses an inductor including a magnetic base body (element body), a plurality of internal conductors provided inside the magnetic base body, a plurality of first external electrodes (terminal electrodes) connected to one end of each of the plurality of internal conductors, and a plurality of second external electrodes (terminal electrodes) connected to the other end of each of the plurality of internal conductors.

### SUMMARY

An inductor according to one aspect of the present disclosure includes an element body formed by including a resin, a coil conductor disposed in the element body, and a terminal connected to the coil conductor, the terminal being exposed from a surface on one side in a first direction of the element body, wherein the terminal has a first region located outside the element body when viewed from the first direction, and a second region provided at a position overlapping with the element body, and a first width of a portion exposed in the first region is wider than a second width of a portion exposed in the second region when viewed from the first direction.

### BRIEF DESCRIPTION OF THE DRAWINGS

FIG. 1 is a view of an inductor according to an embodiment viewed from a second side surface.

FIG. 2 is a view of the inductor shown in FIG. 1 viewed from a third side surface.

FIG. 3 is a view of the inductor shown in FIG. 1 viewed from a fourth side surface.

FIG. 4 is a view of the inductor shown in FIG. 1 viewed from a first main surface.

FIG. 5 is a view of the inductor shown in FIG. 1 viewed from a second main surface.

FIG. 6 is an enlarged view showing a part of FIG. 5.

FIG. 7A is a view showing a cross-sectional configuration taken along line a-a in FIGS. 6, and 7B is a view showing a cross-sectional configuration taken along line b-b in FIG. 6.

FIG. 8 is an enlarged view showing a part of a cross section of an element body and a first terminal (third terminal).

FIG. 9 is an enlarged view showing a part of FIG. 5.

FIG. 10A is a view showing a cross-sectional configuration taken along line a-a in FIGS. 9, and 10B is a view showing a cross-sectional configuration taken along line b-b in FIG. 9.

FIG. 11 is a diagram showing a circuit of a DC-DC converter in which the inductor 1 is used.

FIG. 12 is a view of an inductor according to another embodiment viewed from a third side surface.

FIG. 13 is a view of the inductor shown in FIG. 12 viewed from a fourth side surface.

FIG. 14 is a view of the inductor shown in FIG. 12 viewed from a first main surface.

### DETAILED DESCRIPTION

### Problems to be Solved by the Present Disclosure

An object of one aspect of the present disclosure is to provide an inductor and a DC-DC converter capable of suppressing occurrence of a short circuit failure during mounting while achieving improvement in fixation strength.

### Effects of Present Disclosure

According to one aspect of the present disclosure, it is possible to suppress occurrence of a short circuit failure during mounting while achieving improvement in fixation strength.

### Description of Embodiments of Present Disclosure

Specific examples of the embodiment of the present disclosure will be described below with reference to the drawings. The present disclosure is not limited to these examples, but is defined by the claims, and is intended to include all modifications within the meaning and scope equivalent to the claims. In the description of the drawings, the same elements are denoted by the same reference numerals, and redundant description thereof will be omitted.

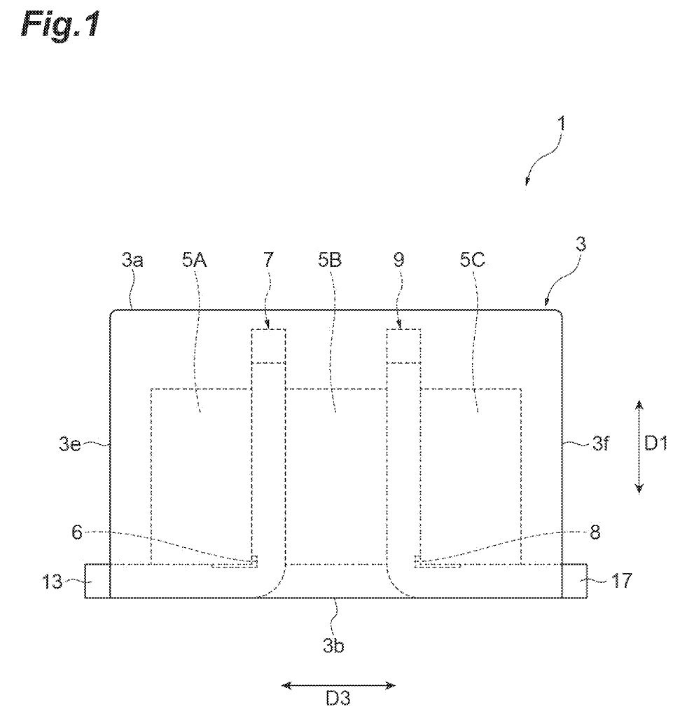

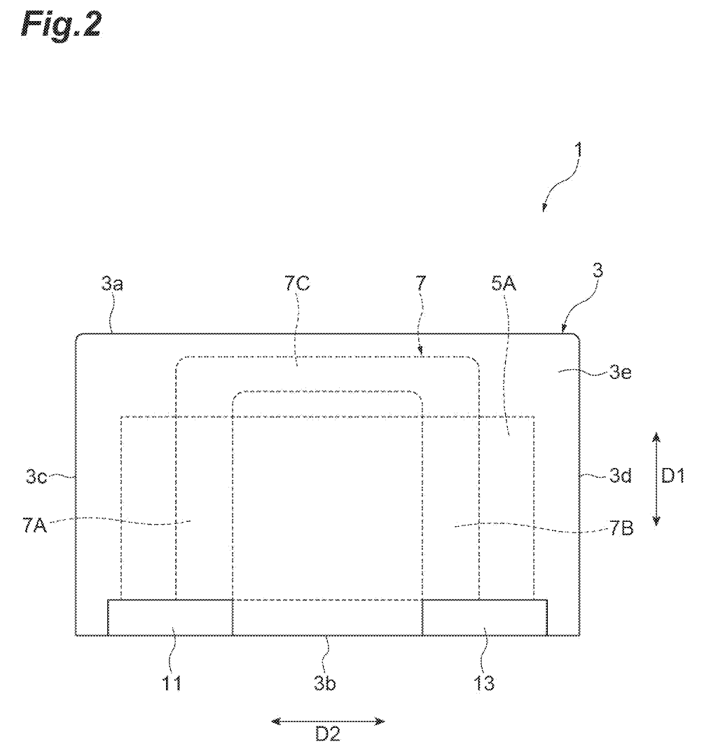

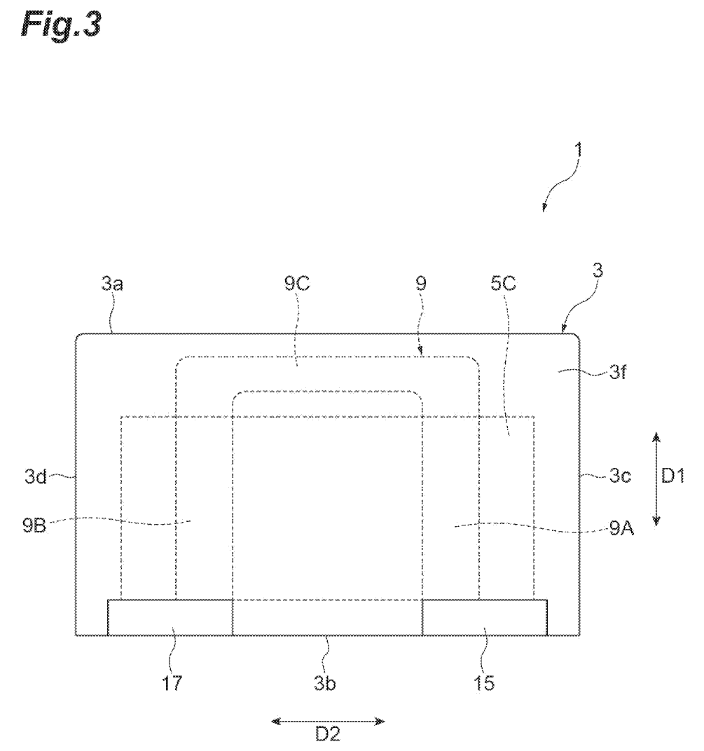

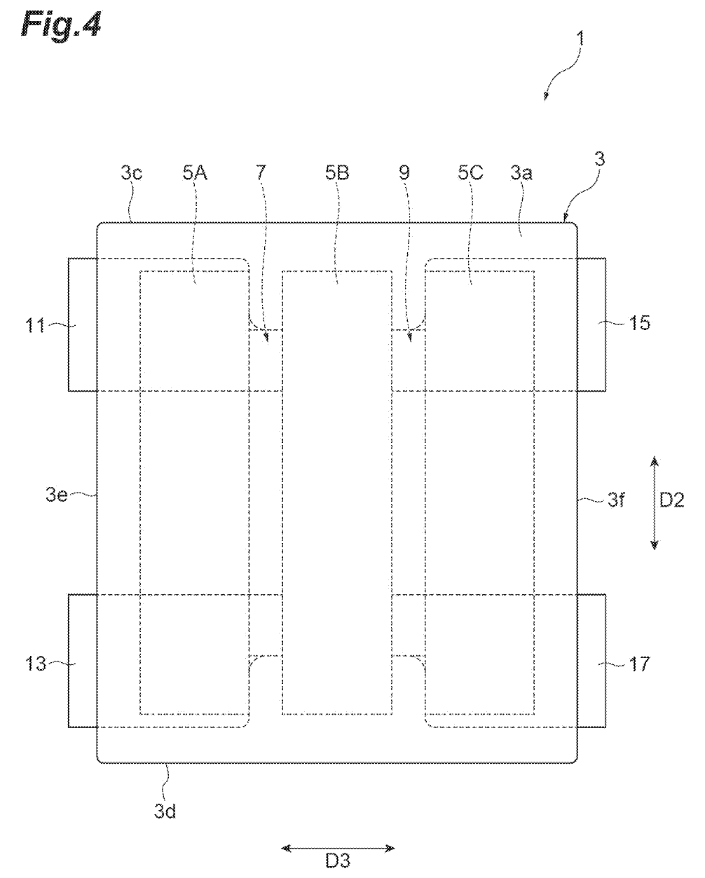

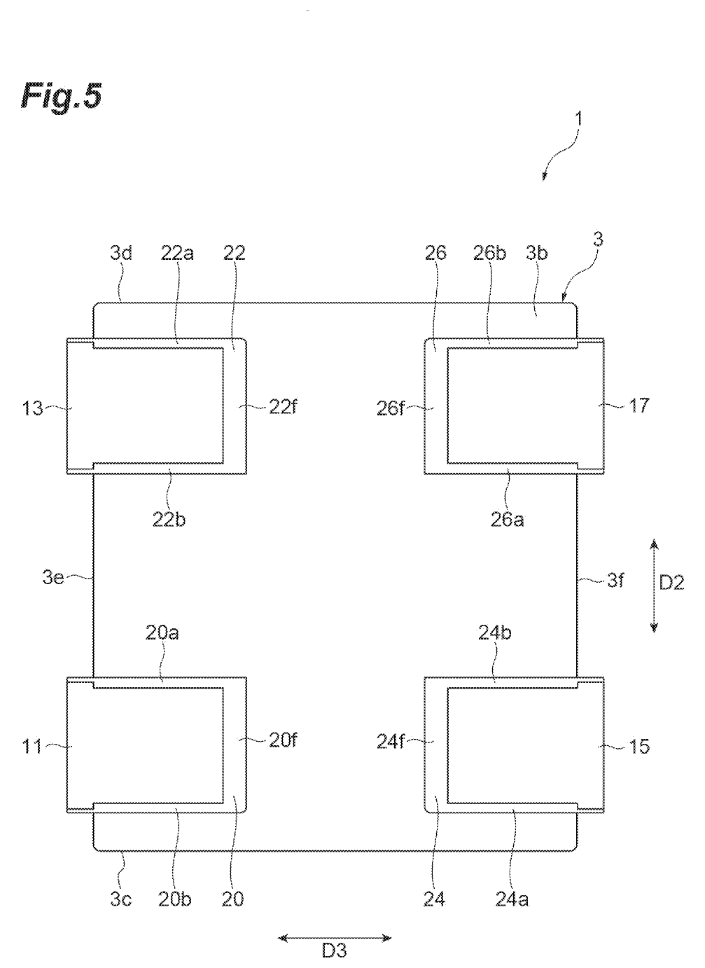

FIG. 1 is a view of an inductor according to an embodiment viewed from a second side surface. FIG. 2 is a view of the inductor shown in FIG. 1 viewed from a third side surface. FIG. 3 is a view of the inductor shown in FIG. 1 viewed from a fourth side surface. FIG. 4 is a view of the inductor shown in FIG. 1 viewed from a first main surface. FIG. 5 is a view of the inductor shown in FIG. 1 viewed from a second main surface.

As shown in FIGS. 1-5, the inductor 1 includes an element body 3, a first magnetic block 5A, a second magnetic block 5B and a third magnetic block 5C, a first coil conductor 7 and a second coil conductor 9, and a first terminal 11, a second terminal 13, a third terminal 15 and a fourth terminal 17.

The element body 3 exhibits a rectangular parallelepiped shape. The rectangular parallelepiped shape includes a rectangular parallelepiped shape in which corners and ridges are chamfered, and a rectangular parallelepiped shape in which corners and ridges are rounded. The element body 3 has, as its outer surfaces, a first main surface 3a and a second main surface (mounting surface) 3b facing each other, and a first side surface 3c, a second side surface 3d, a third side surface 3e and a fourth side surface 3f connecting the first main surface 3a and the second main surface 3b. The first side surface 3c and the second side surface 3d face each other. The third side surface 3e and the fourth side surface 3f face each other. An opposing direction in which the first main surface 3a and the second main surface 3b face each other is a first direction D1. An opposing direction in which the first side surface 3c and the second side surface 3d face each other is a second direction D2. An opposing direction in which the third side surface 3e and the fourth side surface 3f face each other is a third direction D3.

In the present embodiment, the first direction D1 is a height direction of the element body 3. The second direction D2 is, for example, a width direction of the element body 3, and is orthogonal to the first direction D1. The third direction D3 is, for example, a length direction of the element body 3, and is orthogonal to the second direction D2 and the first direction D1.

The second main surface 3b can be defined as a mounting surface facing another electronic device when the inductor 1 is mounted on the other electronic device (for example, a circuit board, an electronic component, or the like).

The element body 3 is formed by including a resin. In the present embodiment, the element body 3 can be made of a magnetic resin. The magnetic resin is a resin containing magnetic powder (magnetic material), and a thermosetting resin such as epoxy is adopted as a material of the resin. The magnetic resin may adopt a mixture of soft magnetic metal powder and resin, or the like. As the soft magnetic metal powder, an iron-silicon alloy, permalloy, sendust, amorphous, nanocrystalline alloy, or a mixture thereof can be used. Further, when the element body 3 is made of a magnetic resin, the magnetic permeability of the element body 3 may be 5 or more, and may be 20 or more. Furthermore, the magnetic permeability of the element body 3 may be 100 or less, and may be 50 or less. The element body 3 may have a lower magnetic permeability than the first magnetic block 5A, the second magnetic block 5B, and the third magnetic block 5C.

The first magnetic block 5A, the second magnetic block 5B, and the third magnetic block 5C are disposed in the element body 3. The first magnetic block 5A, the second magnetic block 5B, and the third magnetic block 5C are arranged in this order in a state of facing each other while being spaced apart from each other in the third direction D3. Each of the first magnetic block 5A, the second magnetic block 5B, and the third magnetic block 5C has a rectangular parallelepiped shape. Each of the first magnetic block 5A, the second magnetic block 5B, and the third magnetic block 5C may have the same shape. Note that each of the first magnetic block 5A, the second magnetic block 5B, and the third magnetic block 5C may have a shape different from each other, or the first magnetic block 5A and the third magnetic block 5C may have the same shape, and the first magnetic block 5A and the third magnetic block 5C and the second magnetic block 5B may have different shapes.

Each of the first magnetic block 5A, the second magnetic block 5B, and the third magnetic block 5C can be made of a magnetic material such as, for example, a sintered magnetic core such as MnZn-based ferrite or NiZn-based ferrite, or a laminated magnetic core formed by laminating soft magnetic metal plates. The magnetic permeability of each of the first magnetic block 5A, the second magnetic block 5B, and the third magnetic block 5C may be 1000 or more. Further, each of the first magnetic block 5A, the second magnetic block 5B, and the third magnetic block 5C may have substantially the same magnetic properties, or may have different magnetic properties.

As shown in FIG. 4, the first magnetic block 5A is disposed at a position closer to the third side surface 3e of the element body 3. The third magnetic block 5C is disposed at a position closer to the fourth side surface 3f of the element body 3. The second magnetic block 5B is disposed between the first magnetic block 5A and the third magnetic block 5C. As shown in FIGS. 1 and 4, the first magnetic block 5A, the second magnetic block 5B, and the third magnetic block 5C are disposed at the same position such that main surfaces and side surfaces overlap each other. Note that a positional deviation within a range caused by a manufacturing error or the like is included in the “same position”.

The first magnetic block 5A is placed on the first terminal 11 and the second terminal 13. The third magnetic block 5C is placed on the third terminal 15 and the fourth terminal 17. A main surface on the first main surface 3a side of the element body 3 in each of the first magnetic block 5A, the second magnetic block 5B, and the third magnetic block 5C is located closer to the second main surface 3b side of the element body 3 in the first direction D1 than each of a third conductor 7C (described later) of the first coil conductor 7 and a sixth conductor 9C (described later) of the second coil conductor 9. Accordingly, when viewed from the third direction D3, a part of an opening formed by a first conductor 7A (described later), a second conductor 7B (described later), and the third conductor 7C of the first coil conductor 7 does not overlap with the first magnetic block 5A, the second magnetic block 5B, and the third magnetic block 5C. Further, when viewed from the third direction D3, a part of an opening formed by a fourth conductor 9A (described later), a fifth conductor 9B (described later), and the sixth conductor 9C of the second coil conductor 9 does not overlap with the first magnetic block 5A, the second magnetic block 5B, and the third magnetic block 5C.

A width in the second direction D2 of each of the first magnetic block 5A, the second magnetic block 5B, and the third magnetic block 5C is wider than a width in the second direction D2 of the first coil conductor 7 (a distance between an end on the first side surface 3c side of the first conductor 7A and an end on the second side surface 3d side of the second conductor 7B). The width in the second direction D2 of each of the first magnetic block 5A, the second magnetic block 5B, and the third magnetic block 5C is wider than a width in the second direction D2 of the second coil conductor 9 (a distance between an end on the first side surface 3c side of the fourth conductor 9A and an end on the second side surface 3d side of the fifth conductor 9B).

As shown in FIGS. 1-3, the first coil conductor 7 and the second coil conductor 9 are disposed in the element body 3. The first coil conductor 7 and the second coil conductor 9 are aligned with the second magnetic block 5B interposed therebetween. The first coil conductor 7 and the second coil conductor 9 are made of a metal selected from, for example, Cu, Ag, Au, Al, Ni, Sn, and the like. The first coil conductor 7 and the second coil conductor 9 are covered with an insulating film (not shown). That is, an insulating film is interposed between each surface of the first coil conductor 7 and the second coil conductor 9 and the element body 3.

The first coil conductor 7 is disposed at a position closer to the third side surface 3e of the element body 3. The first coil conductor 7 is disposed between the first magnetic block 5A and the second magnetic block 5B. The first coil conductor 7 is includes the first conductor 7A, the second conductor 7B, and the third conductor 7C. The first conductor 7A, the second conductor 7B, and the third conductor 7C are integrally formed.

The first conductor 7A is disposed at a position closer to the first side surface 3c of the element body 3. The first conductor 7A extends along the first direction D1. The second conductor 7B is disposed at a position closer to the second side surface 3d of the element body 3. The second conductor 7B extends along the first direction D1. The second conductor 7B is disposed at a position facing the first conductor 7A in the second direction D2. The second conductor 7B is disposed at a predetermined interval from (aligned with) the first conductor 7A in the second direction D2. The third conductor 7C connects the first conductor 7A and the second conductor 7B. The third conductor 7C connects an end on the first main surface 3a side of the first conductor 7A and an end on the first main surface 3a side of the second conductor 7B. The third conductor 7C extends along the second direction D2.

The second coil conductor 9 is disposed at a position closer to the fourth side surface 3f of the element body 3. The second coil conductor 9 is disposed between the second magnetic block 5B and the third magnetic block 5C. The second coil conductor 9 includes the fourth conductor 9A, the fifth conductor 9B, and the sixth conductor 9C. The fourth conductor 9A, the fifth conductor 9B, and the sixth conductor 9C are integrally formed.

The fourth conductor 9A is disposed at a position closer to the first side surface 3c of the element body 3. The fourth conductor 9A extends along the first direction D1. The fifth conductor 9B is disposed at a position closer to the second side surface 3d of the element body 3. The fifth conductor 9B extends along the first direction D1. The fifth conductor 9B is disposed at a position facing the fourth conductor 9A in the second direction D2. The fifth conductor 9B is disposed at a predetermined interval from (aligned with) the fourth conductor 9A in the second direction D2. The sixth conductor 9C connects the fourth conductor 9A and the fifth conductor 9B. The sixth conductor 9C connects an end on the first main surface 3a side of the fourth conductor 9A and an end on the first main surface 3a side of the fifth conductor 9B. The sixth conductor 9C extends along the second direction D2.

The first terminal 11 is exposed from the second main surface 3b. The first terminal 11 is disposed at a position closer to the first side surface 3c and a position closer to the third side surface 3e of the element body 3. An insulating film 20 is provided between the first terminal 11 and the element body 3. The first terminal 11 is connected to one end of the first coil conductor 7. The first terminal 11 is connected to an end on the second main surface 3b side of the first conductor 7A. The first terminal 11 has a rectangular parallelepiped shape. A width in the second direction D2 of the first terminal 11 is larger than a width in the second direction D2 of the first conductor 7A. In the present embodiment, the first terminal 11 protrudes outside the element body 3 beyond the third side surface 3e of the element body 3. As shown in FIG. 2, an end face of the first terminal 11 is exposed when viewed from the third direction D3.

As shown in FIG. 5, the second terminal 13 is exposed from the second main surface 3b. The second terminal 13 is disposed at a position closer to the second side surface 3d and a position closer to the third side surface 3e of the element body 3. The second terminal 13 is connected to the other end of the first coil conductor 7. The second terminal 13 is connected to an end on the second main surface 3b side of the second conductor 7B. An insulating film 22 is provided between the second terminal 13 and the element body 3. The second terminal 13 has a rectangular parallelepiped shape. A width in the second direction D2 of the second terminal 13 is larger than a width in the second direction D2 of the second conductor 7B. In the present embodiment, the second terminal 13 protrudes outside the element body 3 beyond the third side surface 3e of the element body 3. As shown in FIG. 2, an end face of the second terminal 13 is exposed when viewed from the third direction D3.

As shown in FIG. 5, the third terminal 15 is exposed from the second main surface 3b. The third terminal 15 is disposed at a position closer to the first side surface 3c and a position closer to the fourth side surface 3f of the element body 3. The third terminal 15 is connected to one end of the second coil conductor 9. The third terminal 15 is connected to an end on the second main surface 3b side of the fourth conductor 9A. An insulating film 24 is provided between the third terminal 15 and the element body 3. The third terminal 15 has a rectangular parallelepiped shape. A width in the second direction D2 of the third terminal 15 is larger than a width in the second direction D2 of the fourth conductor 9A. In the present embodiment, the third terminal 15 protrudes outside the element body 3 beyond the fourth side surface 3f of the element body 3. As shown in FIG. 3, an end face of the third terminal 15 is exposed when viewed from the third direction D3.

As shown in FIG. 5, the fourth terminal 17 is exposed from the second main surface 3b. The fourth terminal 17 is disposed at a position closer to the second side surface 3d and a position closer to the fourth side surface 3f of the element body 3. The fourth terminal 17 is connected to the other end of the second coil conductor 9. The fourth terminal 17 is connected to an end on the second main surface 3b side of the fifth conductor 9B. An insulating film 26 is provided between the fourth terminal 17 and the element body 3. The fourth terminal 17 has a rectangular parallelepiped shape. A width in the second direction D2 of the fourth terminal 17 is larger than a width in the second direction D2 of the fifth conductor 9B. In the present embodiment, the fourth terminal 17 protrudes outside the element body 3 beyond the fourth side surface 3f of the element body 3. As shown in FIG. 3, an end face of the fourth terminal 17 is exposed when viewed from the third direction D3.

As shown in FIG. 5, the first terminal 11 and the second terminal 13 are disposed at positions facing each other at a predetermined interval in the second direction D2. The third terminal 15 and the fourth terminal 17 are disposed at positions facing each other at a predetermined interval in the second direction D2. The first terminal 11 and the third terminal 15 are disposed at positions facing each other at a predetermined interval in the third direction D3. The second terminal 13 and the fourth terminal 17 are disposed at positions facing each other at a predetermined interval in the third direction D3.

As shown in FIG. 1, a recess 6 may be provided at a connection portion between the second terminal 13 and the second conductor 7B of the first coil conductor 7. A recess 8 may be provided at a connection portion between the fourth terminal 17 and the fifth conductor 9B of the second coil conductor 9. Similarly, a recess may be provided at a connection portion between the first terminal 11 and the first conductor 7A of the first coil conductor 7. A recess may be provided at a connection portion between the third terminal 15 and the fourth conductor 9A of the second coil conductor 9.

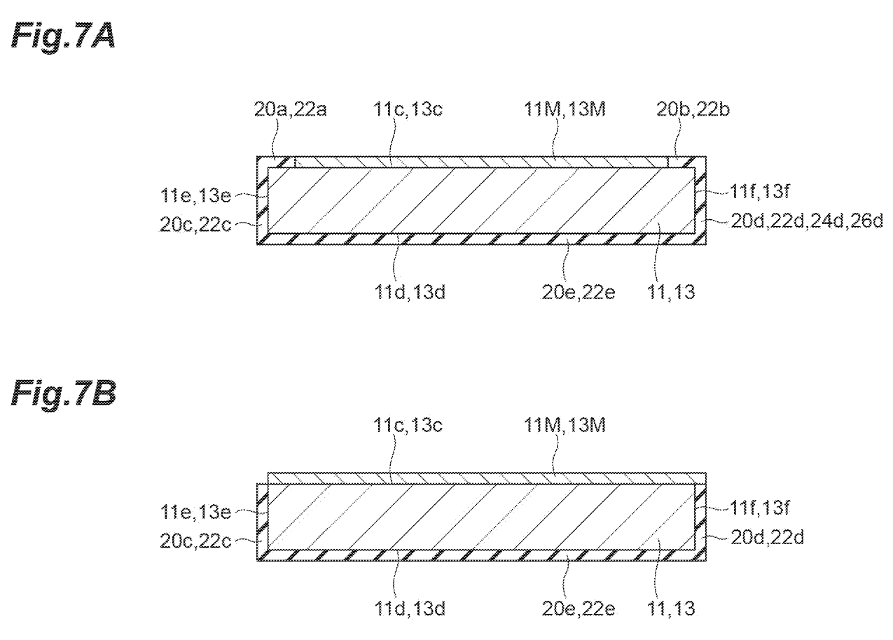

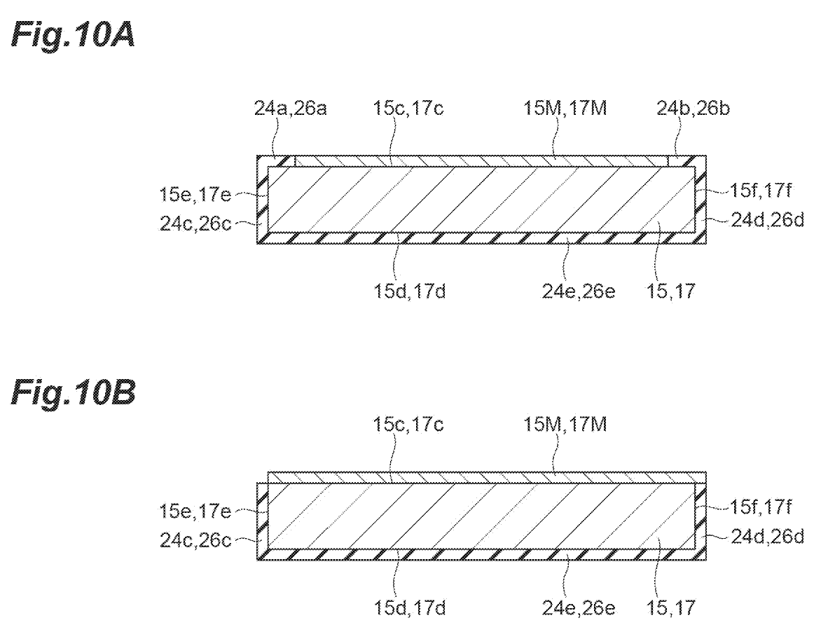

The first terminal 11 is provided with a plating layer 11M (see FIG. 7A) containing, for example, Ni, Cu, Sn, Ag, Au, or the like, formed by electrolytic plating or electroless plating. The plating layer 11M may include, for example, a plurality of plating films. Similarly, the second terminal 13 is provided with a plating layer 13M (see FIG. 7A). The third terminal 15 is provided with a plating layer 15M (see FIG. 10A). The fourth terminal 17 is provided with a plating layer 17M (see FIG. 10A).

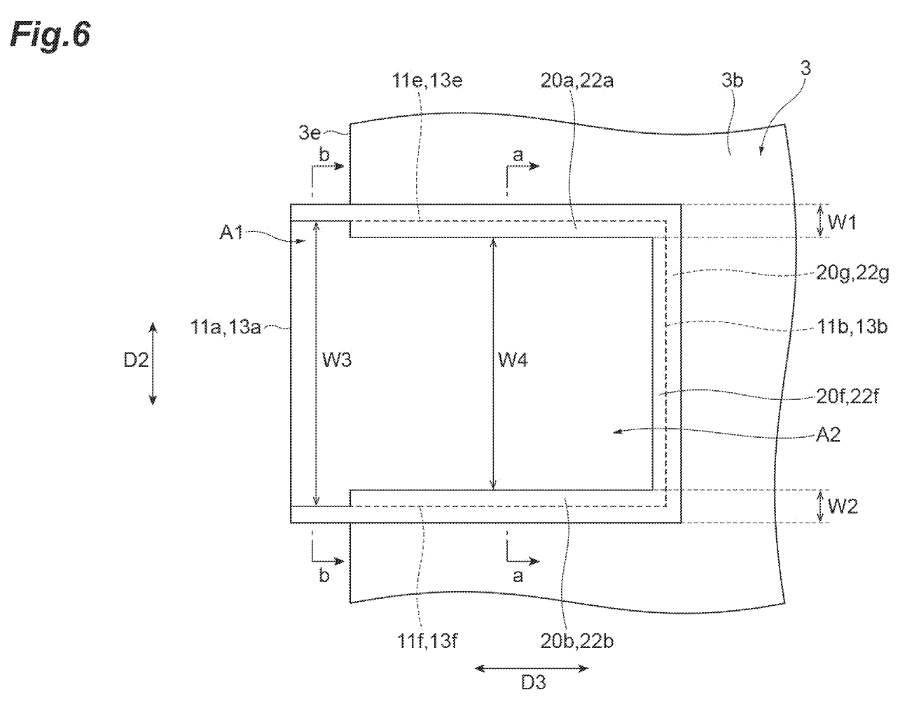

FIG. 6 is an enlarged view showing a part of FIG. 5. As shown in FIG. 6, the first terminal 11 has a first region A1 protruding outward in the third direction D3 beyond the third side surface 3e of the element body 3 when viewed from the first direction D1, and a second region A2 overlapping with the element body 3 (located on the second main surface 3b of the element body 3). The first region A1 is a region on a tip side of the first terminal 11. The second region A2 is a region on a base end side connected to the first conductor 7A. The first region A1 and the second region A2 are provided adjacent to (aligned with) each other in the third direction D3.

FIG. 7A is a view showing a cross-sectional configuration taken along line a-a in FIG. 6. FIG. 7B is a view showing a cross-sectional configuration taken along line b-b in FIG. 6. The line a-a includes the second region A2. The line b-b includes the first region A1. As shown in FIGS. 6, 7A, and 7B, the first terminal 11 has a pair of end faces 11a and 11b facing each other, a pair of main surfaces 11c and 11d facing each other, and a pair of side surfaces 11e and 11f facing each other. The pair of end faces 11a and 11b face each other in the third direction D3. The pair of main surfaces 11c and 11d face each other in the first direction D1. The pair of side surfaces 11e and 11f face each other in the second direction D2.

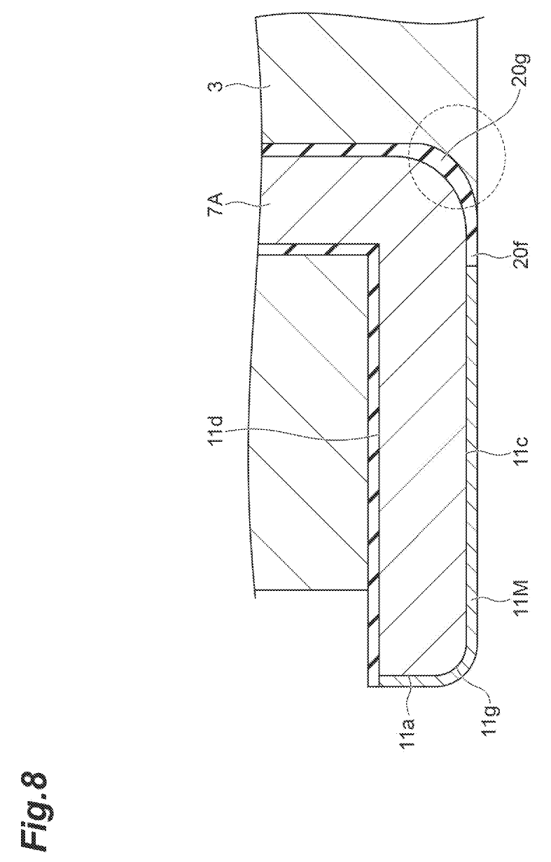

FIG. 8 is an enlarged view showing a part of a cross section of the first terminal 11 (second terminal 13). As shown in FIG. 8, in the first terminal 11, a surface on the tip side of the first region A1 is curved toward the tip. The first terminal 11 has a curved surface 11g. The curved surface 11g is a surface (surface on the tip side) connecting the end face 11a and the main surface 11c of the first terminal 11. The curved surface 11g is curved in a convex shape.

As shown in FIGS. 7A, 7B, and 8, the first terminal 11 is provided with the plating layer 11M. The plating layer 11M is provided on the end face 11a, the main surface 11c, and the curved surface 11g. The plating layer 11M has a predetermined thickness.

The insulating film 20 is provided on a surface of the first terminal 11. The insulating film 20 electrically insulates the first terminal 11 and the element body 3. The insulating film 20 can be configured with, for example, polyimide, epoxy, urethane, ceramic, glass, or the like. The insulating film 20 is provided on a part of the main surface 11c of the first terminal 11, and on the main surface 11d and the side surfaces 11e and 11f of the first terminal 11. Specifically, the insulating film 20 has a first portion 20a, a second portion 20b, a third portion 20c, a fourth portion 20d, a fifth portion 20e, a sixth portion 20f, and a seventh portion 20g.

The first portion 20a is disposed at an edge on the side surface 11e side on the main surface 11c. The first portion 20a defines the second region A2. The first portion 20a extends in the third direction D3. The second portion 20b is disposed at an edge on the side surface 11f side on the main surface 11c. The second portion 20b defines the second region A2. The second portion 20b extends in the third direction D3. The second portion 20b is disposed at a position facing the first portion 20a in the second direction D2.

The third portion 20c is disposed on the side surface 11e. A part of the third portion 20c is provided between the element body 3 and the first terminal 11 (side surface 11e). The third portion 20c extends in the third direction D3. The first portion 20a and the third portion 20c constitute a first insulating part. The fourth portion 20d is disposed on the side surface 11f. A part of the fourth portion 20d is provided between the element body 3 and the first terminal 11 (side surface 11f). The fourth portion 20d extends in the third direction D3. The second portion 20b and the fourth portion 20d constitute a second insulating part. The fifth portion 20e is disposed on the main surface 11d. A part of the fifth portion 20e is disposed between the element body 3 and the first terminal 11 (main surface 11d).

The sixth portion 20f is disposed at an edge on the end face 11b side. The sixth portion 20f defines the second region A2. The sixth portion 20f extends in the second direction D2. The seventh portion 20g is disposed between the element body 3 and the first terminal 11 (end face 11b). The seventh portion 20g extends in the second direction D2. The sixth portion 20f and the seventh portion 20g constitute a third insulating part.

A width W1 (length in the second direction D2) of the first portion 20a may be equal to a width W2 (length in the second direction D2) of the second portion 20b (W1=W2). The width W1 of the first portion 20a may be wider than the width W2 of the second portion 20b (W1>W2). The width W1 of the first portion 20a may be narrower than the width W2 of the second portion 20b (W1<W2).

As shown in FIG. 6, in the first terminal 11, a width (first width) W3 of a portion exposed in the first region A1 is wider than a width (second width) W4 of a portion exposed in the second region A2 when viewed from the first direction D1 (W3>W4). The width W3 and the width W4 are lengths in the second direction D2. The width W3 is a width in the second direction D2 of the first terminal 11. That is, in the first region A1, the entire surface of the first region A1 is exposed. The width W4 is a length between the first portion 20a and the second portion 20b of the insulating film 20 in the first terminal 11. That is, in the second region A2, a portion not covered by the first portion 20a and the second portion 20b of the insulating film 20 is exposed. In the first region A1 and the second region A2, the plating layer 11M is formed on the exposed portion. In the first region A1 of the first terminal 11, the plating layer 11M is formed on the entire surface of the main surface 11c.

As shown in FIG. 8, a part of the seventh portion 20g of the insulating film 20 is provided in the element body 3. It can also be said that a part of the seventh portion 20g is covered by the element body 3. A content of magnetic powder per unit volume in a portion of the element body 3 covering the seventh portion 20g (for example, a portion surrounded by a dotted line in FIG. 8) is smaller than that in other portions of the element body 3.

The second terminal 13 also has the same configuration as the first terminal 11. The second terminal 13 has a pair of end faces 13a and 13b facing each other, a pair of main surfaces 13c and 13d facing each other, and a pair of side surfaces 13e and 13f facing each other. The insulating film 22 (see FIG. 6) is provided on a surface of the second terminal 13. The insulating film 22 has a first portion 22a, a second portion 22b, a third portion 22c, a fourth portion 22d, a fifth portion 22e, a sixth portion 22f, and a seventh portion 22g. In the second terminal 13, the width W3 of a portion exposed in the first region A1 is wider than the width W4 of a portion exposed in the second region A2 when viewed from the first direction D1 (W3>W4).

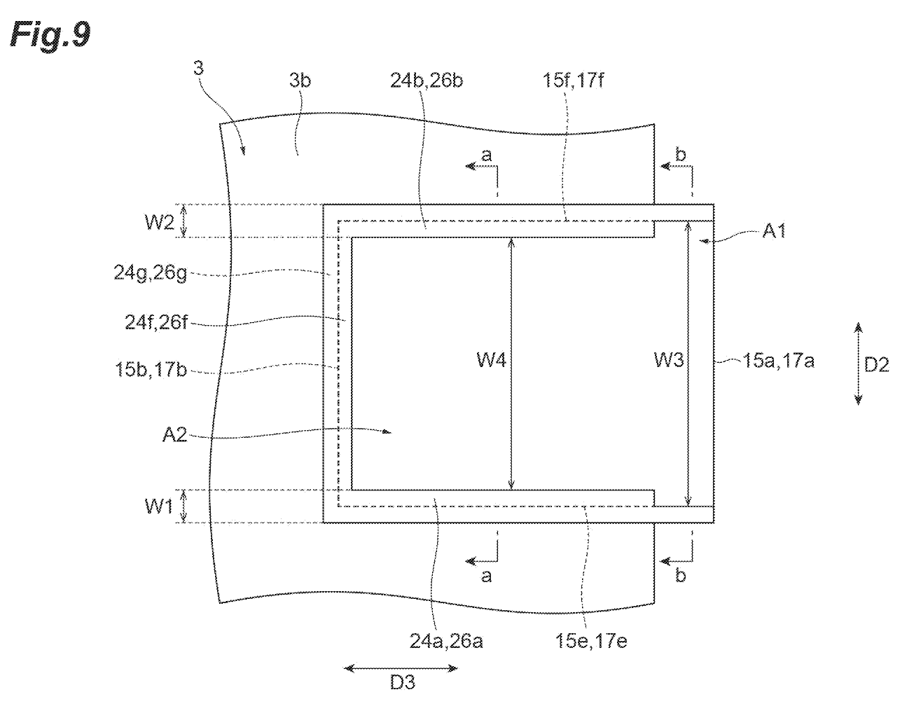

FIG. 9 is an enlarged view showing a part of FIG. 5. FIG. 10A is a view showing a cross-sectional configuration taken along line a-a in FIG. 9. FIG. 10B is a view showing a cross-sectional configuration taken along line b-b in FIG. 9. The line a-a includes the second region A2. The line b-b includes the first region A1. The third terminal 15 and the fourth terminal 17 also have the same configuration as the first terminal 11. The third terminal 15 has a pair of end faces 15a and 15b facing each other, a pair of main surfaces 15c and 15d facing each other, and a pair of side surfaces 15e and 15f facing each other. The insulating film 24 (see FIG. 6) is provided on a surface of the third terminal 15. The insulating film 24 has a first portion 24a, a second portion 24b, a third portion 24c, a fourth portion 24d, a fifth portion 24e, a sixth portion 24f, and a seventh portion 24g.

The fourth terminal 17 has a pair of end faces 17a and 17b facing each other, a pair of main surfaces 17c and 17d facing each other, and a pair of side surfaces 17e and 17f facing each other. The insulating film 26 (see FIG. 6) is provided on a surface of the fourth terminal 17. The insulating film 26 has a first portion 26a, a second portion 26b, a third portion 26c, a fourth portion 26d, a fifth portion 26e, a sixth portion 26f, and a seventh portion 26g. In each of the third terminal 15 and the fourth terminal 17, the width W3 of a portion exposed in the first region A1 is wider than the width W4 of a portion exposed in the second region A2 when viewed from the first direction D1 (W3>W4).

Subsequently, a method for manufacturing the inductor 1 will be described. When manufacturing the inductor 1, a member in which the first coil conductor 7, the first terminal 11, and the second terminal 13 are integrated, and a member in which the second coil conductor 9, the third terminal 15, and the fourth terminal 17 are integrated are prepared, and an insulating film is formed on surfaces of these members. Subsequently, the members are arranged in the order of the first magnetic block 5A, the first coil conductor 7, the second magnetic block 5B, the second coil conductor 9, and the third magnetic block 5C, and are molded with a magnetic resin. Accordingly, the element body 3 in which the first magnetic block 5A, the first coil conductor 7, the second magnetic block 5B, the second coil conductor 9, and the third magnetic block 5C are integrated is obtained.

Subsequently, a part of the insulating film covering each terminal is removed. Specifically, for example, the insulating film is removed by a laser or the like. The insulating film is removed such that the entire surface of the first region A1 is exposed and the width W3 of the first region A1 becomes wider than the width W4 of the second region A2. That is, in a portion where the terminal protrudes from the element body 3, the insulating film of the terminal is removed by a laser such that the entire surface of the terminal is exposed (such that the exposed width becomes the conductor width). In a portion where the terminal does not protrude from the element body 3, the insulating film is removed by a laser such that the insulating film remains on a part of the surface of the terminal. Then, a plating layer is formed on the portion where the terminal is exposed. In this manner, the inductor 1 can be manufactured.

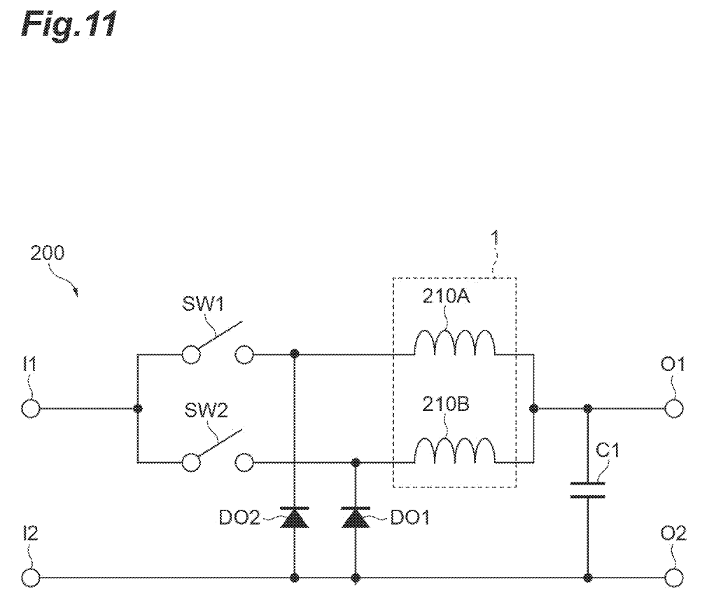

FIG. 11 is a diagram showing a circuit of a DC-DC converter in which the inductor 1 is used. As shown in FIG. 11, the first coil conductor 7 and the second coil conductor 9 of the inductor 1 can be adopted for each choke coil of a circuit of a DC-DC converter 200. The DC-DC converter 200 is a multi-phase converter including a pair of conversion units that include switching elements SW1 and SW2, choke coils 210A and 210B, and diodes DO1 and DO2, wherein these conversion units are connected in parallel, and the inductor 1 can be adopted as the choke coils 210A and 210B of each conversion unit.

The DC-DC converter 200 includes a pair of input terminals I1 and I2, a pair of output terminals O1 and O2, the switching element SW1 and the choke coil 210A connected in series in this order between the input terminal I1 and the output terminal O1, the switching element SW2 and the choke coil 210B connected in series in this order between the input terminal I1 and the output terminal O1, and a capacitor C1 connected between the output terminals O1 and O2. A circuit consisting of the switching element SW1 and the choke coil 210A and a circuit consisting of the switching element SW2 and the choke coil 210B are connected in parallel between the input terminal I1 and the output terminal O1. The input terminal I2 and the output terminal O2 constitute a ground line.

The diode DO2 is reversely connected between a connection point of the switching element SW1 and the choke coil 210A and the ground line, and the diode DO1 is reversely connected between a connection point of the switching element SW2 and the choke coil 210B and the ground line. The switching elements SW1 and SW2 are alternately turned on and off by a control circuit (not shown), whereby an output voltage obtained by stepping down an input voltage is generated. By configuring the pair of choke coils 210A and 210B in the DC-DC converter 200 with the first coil conductor 7 and the second coil conductor 9 of the inductor 1, the number of components configuring the DC-DC converter 200 can be reduced.

As described above, in the inductor 1 according to the present embodiment, the first terminal 11 has the first region A1 located outside the element body 3 when viewed from the first direction D1, and the second region A2 provided at a position overlapping with the element body 3. When viewed from the first direction D1, the width W3 of the portion exposed in the first region A1 is wider than the width W4 of the portion exposed in the second region A2 (W3>W4). Thus, in the inductor 1, since the width W3 of the first region A1 is wide, an area to which solder adheres can be increased when the inductor 1 is mounted on a circuit board or the like with solder. Therefore, in the inductor 1, improvement in fixation strength can be achieved.

Further, in the inductor 1, the width W4 of the second region A2 where the first terminal 11 overlaps with the element body 3 is narrower than the width W3 of the first region A1. Thus, in the inductor 1, since the width W4 of the second region A2 is narrower than the width W3, an amount of solder in the second region A2 is reduced when the inductor 1 is mounted on a circuit board or the like with solder. This makes it possible to prevent solder (solder balls) from remaining between the element body 3 of the inductor 1 and the circuit board. Therefore, in the inductor 1, it is possible to prevent the first terminal 11 from being short-circuited with another conductor with the solder.

In the inductor 1 according to the present embodiment, similarly to the first terminal 11, regarding the second terminal 13, the third terminal 15, and the fourth terminal 17 as well, the width W3 of the portion exposed in the first region A1 is wider than the width W4 of the portion exposed in the second region A2 when viewed from the first direction D1 (W3>W4). This configuration makes it possible to suppress occurrence of a short circuit between the first terminal 11 and the second terminal 13, and between the third terminal 15 and the fourth terminal 17.

In the inductor 1 according to the present embodiment, the insulating film 20 (first portion 20a) and the insulating film 22 (second portion 22b) are provided between the first terminal 11 and the second terminal 13. This configuration makes it possible to ensure insulation between the first terminal 11 and the second terminal 13. The insulating film 24 (second portion 24b) and the insulating film 26 (first portion 26a) are provided between the third terminal 15 and the fourth terminal 17. This configuration makes it possible to ensure insulation between the third terminal 15 and the fourth terminal 17.

In the inductor 1 according to the embodiment, the insulating film 20 (sixth portion 20f) and the insulating film 24 (sixth portion 24f) are provided between the first terminal 11 and the third terminal 15. This configuration makes it possible to ensure insulation between the first terminal 11 and the third terminal 15. The insulating film 24 (sixth portion 24f) and the insulating film 26 (sixth portion 26f) are provided between the second terminal 13 and the fourth terminal 17. This configuration makes it possible to ensure insulation between the second terminal 13 and the fourth terminal 17.

In the inductor 1 according to the present embodiment, the entire surface of the first region A1 is exposed when viewed from the first direction D1. In this configuration, the area to which solder adheres can be increased, and thus improvement in fixation strength can be achieved.

In the inductor 1 according to the present embodiment, in the first terminal 11, a tip portion of the first region A1 is curved from the surface of the first region A1 toward the tip side. In this configuration, when the inductor 1 is mounted on a circuit board or the like with solder, solder is formed on the curved portion. This makes it possible to achieve improvement in fixation strength of the first terminal 11 to the circuit board or the like.

The inductor 1 according to the present embodiment includes the insulating film 20 that insulates the element body 3 and the first terminal 11. The insulating film 20 has the first portion 20a and the third portion 20c provided on the side surface 11e side of the first terminal 11, and the second portion 20b and the fourth portion 20d provided on the side surface 11f side of the first terminal 11. The first portion 20a and the second portion 20b define the second region A2. In this configuration, the first portion 20a and the second portion 20b are provided such that the second region A2 overlapping with the element body 3 is defined by the first portion 20a and the second portion 20b, and thus it is possible to suppress a plating solution from extending to the element body 3 side when forming the plating layer 11M. This ensures electrical insulation between the element body 3 and the first terminal 11 in the inductor 1. The same applies to the second terminal 13, the third terminal 15, and the fourth terminal 17.

In the inductor 1 according to the present embodiment, in the element body 3, the content of magnetic powder per unit volume in the portion covering a part of the seventh portion 20g is lower than the content of magnetic powder per unit volume in other portions of the element body 3. This configuration lowers the magnetic density of the portion covering a part of the seventh portion 20g in the element body 3.

Although the embodiments of the present disclosure have been described above, the present disclosure is not necessarily limited to the above-described embodiments, and various modifications are possible without departing from the gist thereof.

In the above embodiment, a mode in which the insulating film 20 has the first insulating part (first portion 20a, third portion 20c) and the second insulating part (second portion 20b, fourth portion 20d) has been described as an example. However, the insulating film 20 may have only the first insulating part, or may have only the second insulating part.

In the above embodiment, a mode in which the entire surface of the first region A1 is exposed has been described as an example. That is, a mode in which the insulating film is removed such that the entire surface of the first region A1 is exposed, and the plating layer is formed on the entire surface of the first region A1 has been described as an example. However, in the removal step of the insulating film, the insulating film may remain on a part of the first region A1. That is, in the first region A1, a part of the surface may not be exposed. In the electronic component, it is sufficient that the first width of the portion exposed in the first region A1 is wider than the second width of the portion exposed in the second region A2 when viewed from the first direction D1.

In the above embodiment, structures of the first magnetic block 5A, the second magnetic block 5B, and the third magnetic block 5C, and the first coil conductor 7 and the second coil conductor 9 are not limited.

In the above embodiment, a mode in which a part of the first terminal 11, the second terminal 13, the third terminal 15, and the fourth terminal 17 is located inside the element body 3 and a part thereof is exposed from the second main surface 3b of the element body 3 has been described as an example. However, the first terminal 11, the second terminal 13, the third terminal 15, and the fourth terminal 17 may be disposed on the second main surface 3b of the element body 3.

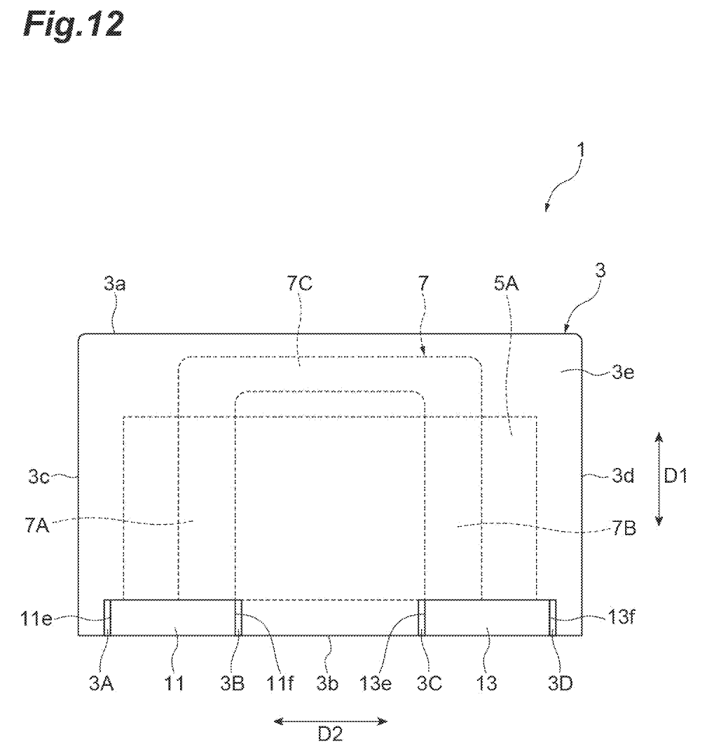

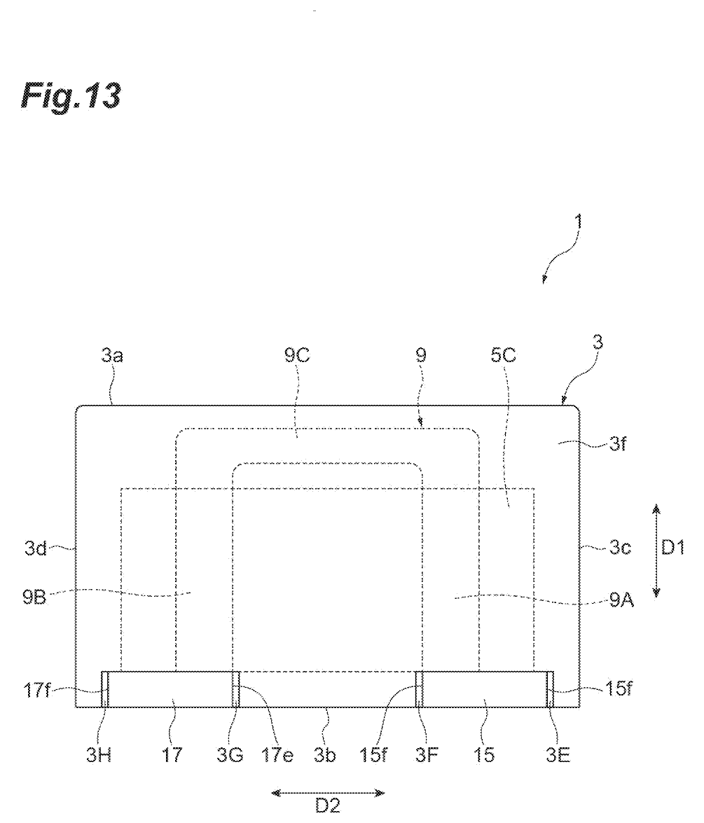

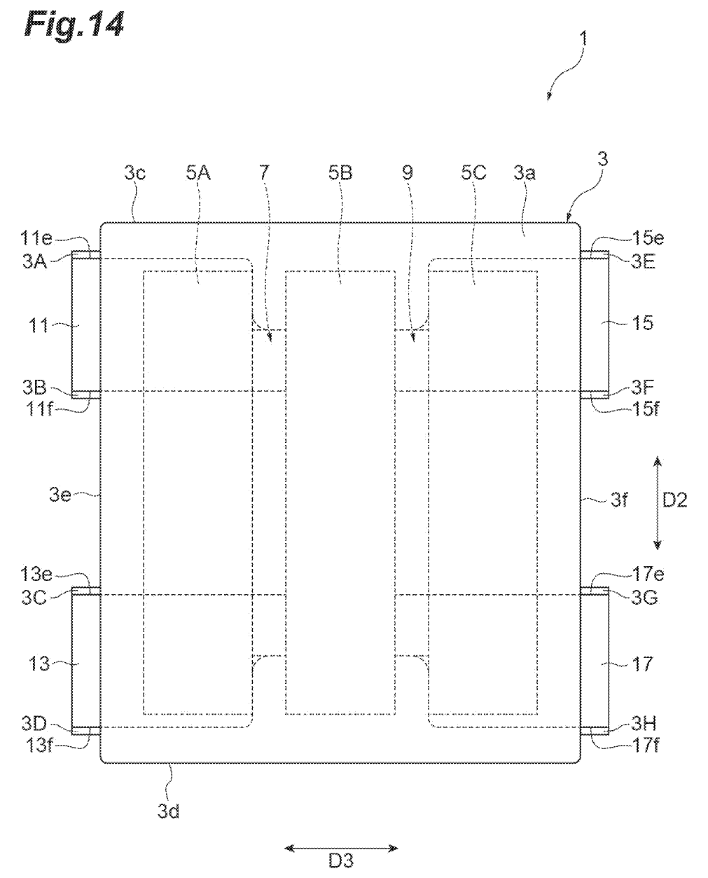

In addition to the above embodiment, as shown in FIGS. 12, 13, and 14, in the first terminal 11, the second terminal 13, the third terminal 15, and the fourth terminal 17, each of a pair of side surfaces in the second direction D2 of a portion protruding beyond the element body 3 may be covered by a part of the element body 3.

In the first terminal 11, element body portions 3A and 3B which are parts of the element body 3 are provided on the side surfaces 11e and 11f of the portion protruding outward beyond the element body 3, respectively. In the second terminal 13, element body portions 3C and 3D which are parts of the element body 3 are provided on the side surfaces 13e and 13f of the portion protruding outward beyond the element body 3, respectively. In the third terminal 15, element body portions 3E and 3F which are parts of the element body 3 are provided on the side surfaces 15e and 15f of the portion protruding outward beyond the element body 3, respectively. In the fourth terminal 17, element body portions 3G and 3H which are parts of the element body 3 are provided on the side surfaces 17e and 17f of the portion protruding outward beyond the element body 3, respectively.

In such a configuration, in the first terminal 11, the second terminal 13, the third terminal 15, and the fourth terminal 17, since the side surfaces in the second direction D2 of the portion protruding beyond the element body 3 are covered by a part of the element body 3 (element body portion), improvement in rigidity of the protruding portion can be achieved.

In the above embodiment, a mode in which the element body portions 3A, 3B, 3C, 3D, 3E, 3F, 3G, and 3H are provided in the first terminal 11, the second terminal 13, the third terminal 15, and the fourth terminal 17, respectively, has been described as an example. However, the element body portions 3A, 3B, 3C, 3D, 3E, 3F, 3G, and 3H do not necessarily have to be all provided, and a part thereof may be provided. Further, in the first terminal 11, the second terminal 13, the third terminal 15, and the fourth terminal 17, each of the pair of side surfaces in the second direction D2 of the portion protruding beyond the element body 3 may be entirely covered by a part of the element body 3, or may be partially covered.

As understood from the above description, the present specification discloses the following.

### Supplementary Note 1

An inductor comprising:
an element body formed by including a resin;
a coil conductor disposed in the element body; and
a terminal connected to the coil conductor, the terminal being exposed from a surface on one side in a first direction of the element body,
wherein the terminal has a first region located outside the element body when viewed from the first direction, and a second region provided at a position overlapping with the element body, and
a first width of a portion exposed in the first region is wider than a second width of a portion exposed in the second region when viewed from the first direction.

### Supplementary Note 2

The inductor according to Supplementary Note 1, wherein an entire surface of the first region is exposed when viewed from the first direction.

### Supplementary Note 3

The inductor according to Supplementary Note 1 or 2, wherein a surface on a tip side of the first region in the terminal is curved toward the tip.

### Supplementary Note 4

The inductor according to any one of Supplementary Notes 1 to 3,
wherein the coil conductor has a first conductor extending in the first direction, a second conductor extending in the first direction and disposed facing the first conductor in a second direction orthogonal to the first direction, and a third conductor connecting the first conductor and the second conductor,
the terminal includes a first terminal connected to the first conductor, and a second terminal connected to the second conductor,
each of the first terminal and the second terminal has the first region and the second region, and
a width of a portion exposed in the first region is wider than a width of a portion exposed in the second region when viewed from the first direction.

### Supplementary Note 5

The inductor according to Supplementary Note 4, wherein the first region and the second region are adjacent in a third direction orthogonal to the first direction and the second direction when viewed from the first direction.

### Supplementary Note 6

The inductor according to Supplementary Note 4, wherein each of the first terminal and the second terminal has a pair of side surfaces facing each other in the second direction, and a first insulating part in each of the first terminal and the second terminal is provided on one side surface side of the pair of side surfaces that are close to each other in the second direction.

### Supplementary Note 7

The inductor according to Supplementary Note 6, wherein a second insulating part in each of the first terminal and the second terminal is provided on another side surface side of the pair of side surfaces.

### Supplementary Note 8

The inductor according to Supplementary Note 4,
wherein each of the first terminal and the second terminal has a pair of side surfaces facing each other in the second direction,
a first insulating part in each of the first terminal and the second terminal is provided on one side surface side of the pair of side surfaces,
a second insulating part in each of the first terminal and the second terminal is provided on another side surface side of the pair of side surfaces, and
a width of the first insulating part in the second direction is wider than a width of the second insulating part in the second direction.

### Supplementary Note 9

The inductor according to Supplementary Note 4,
wherein each of the first terminal and the second terminal has a pair of side surfaces facing each other in the second direction,
a first insulating part in each of the first terminal and the second terminal is provided on one side surface side of the pair of side surfaces,
a second insulating part in each of the first terminal and the second terminal is provided on another side surface side of the pair of side surfaces, and
a width of the second insulating part in the second direction is wider than a width of the first insulating part in the second direction.

### Supplementary Note 10

The inductor according to any one of Supplementary Notes 4 to 9,
wherein each of the first terminal and the second terminal has a pair of end faces facing each other in a third direction orthogonal to the first direction and the second direction, and
a third insulating part is provided on the end face side of the second region among the pair of end faces.

### Supplementary Note 11

The inductor according to Supplementary Note 10, wherein the element body covers a part of the third insulating part.

### Supplementary Note 12

The inductor according to Supplementary Note 11,
wherein the element body is formed by including a magnetic material, and
a content of the magnetic material per unit volume in a portion covering the part of the third insulating part in the element body is lower than a content of the magnetic material per unit volume in other portions of the element body.

### Supplementary Note 13

The inductor according to Supplementary Note 1,
wherein the element body has a first main surface and a second main surface facing each other,
the second main surface is the surface on the one side in the first direction, and
the terminal is exposed from the second main surface.

### Supplementary Note 14

The inductor according to Supplementary Note 13,

wherein the element body has a third side surface and a fourth side surface connecting the first main surface and the second main surface, and

the terminal includes a first terminal protruding outside the element body beyond the third side surface, and a third terminal protruding outside the element body beyond the fourth side surface.

### Supplementary Note 15

The inductor according to Supplementary Note 14,
wherein an end face of the first terminal is exposed when viewed from the third side surface, and
an end face of the third terminal is exposed when viewed from the fourth side surface.

### Supplementary Note 16

The inductor according to any one of Supplementary Notes 1 to 15, further comprising a first magnetic block, a second magnetic block, and a third magnetic block disposed in the element body,
wherein the first magnetic block, the second magnetic block, and the third magnetic block are disposed spaced apart from each other in a third direction orthogonal to the first direction and a second direction orthogonal to the first direction.

### Supplementary Note 17

The inductor according to Supplementary Note 16, wherein the coil conductor includes a first coil conductor disposed between the first magnetic block and the second magnetic block, and a second coil conductor disposed between the second magnetic block and the third magnetic block.

### Supplementary Note 18

The inductor according to any one of Supplementary Notes 1 to 17, wherein each of a pair of side surfaces in a third direction orthogonal to the first direction and a second direction orthogonal to the first direction of a portion protruding beyond the element body in the terminal is covered by a part of the element body.

### Supplementary Note 19

The inductor according to any one of Supplementary Notes 1 to 18,
wherein a plating layer is provided on the terminal, and the plating layer is formed on a portion exposed in the first region.

### Supplementary Note 20

A DC-DC converter comprising the inductor according to any one of Supplementary Notes 1 to 19.

What is claimed is:

1. An inductor comprising:
an element body formed by including a resin;
a coil conductor disposed in the element body; and
a terminal connected to the coil conductor, the terminal being exposed from a surface on one side in a first direction of the element body,
wherein the terminal has a first region located outside the element body when viewed from the first direction, and a second region provided at a position overlapping with the element body, and
a first width of a portion exposed in the first region is wider than a second width of a portion exposed in the second region when viewed from the first direction.

2. The inductor according to claim 1, wherein an entire surface of the first region is exposed when viewed from the first direction.

3. The inductor according to claim 1, wherein a surface on a tip side of the first region in the terminal is curved toward the tip.

4. The inductor according to claim 1,
wherein the coil conductor has a first conductor extending in the first direction, a second conductor extending in the first direction and disposed facing the first conductor in a second direction orthogonal to the first direction, and a third conductor connecting the first conductor and the second conductor,
the terminal includes a first terminal connected to the first conductor, and a second terminal connected to the second conductor,
each of the first terminal and the second terminal has the first region and the second region, and
a width of a portion exposed in the first region is wider than a width of a portion exposed in the second region when viewed from the first direction.

5. The inductor according to claim 4, wherein the first region and the second region are adjacent in a third direction orthogonal to the first direction and the second direction when viewed from the first direction.

6. The inductor according to claim 4,
wherein each of the first terminal and the second terminal has a pair of side surfaces facing each other in the second direction, and
a first insulating part in each of the first terminal and the second terminal is provided on one side surface side of the pair of side surfaces that are close to each other in the second direction.

7. The inductor according to claim 6, wherein a second insulating part in each of the first terminal and the second terminal is provided on another side surface side of the pair of side surfaces.

8. The inductor according to claim 4,
wherein each of the first terminal and the second terminal has a pair of side surfaces facing each other in the second direction,
a first insulating part in each of the first terminal and the second terminal is provided on one side surface side of the pair of side surfaces,
a second insulating part in each of the first terminal and the second terminal is provided on another side surface side of the pair of side surfaces, and
a width of the first insulating part in the second direction is wider than a width of the second insulating part in the second direction.

9. The inductor according to claim 4,
wherein each of the first terminal and the second terminal has a pair of side surfaces facing each other in the second direction,
a first insulating part in each of the first terminal and the second terminal is provided on one side surface side of the pair of side surfaces,
a second insulating part in each of the first terminal and the second terminal is provided on another side surface side of the pair of side surfaces, and
a width of the second insulating part in the second direction is wider than a width of the first insulating part in the second direction.

10. The inductor according to claim 4,
wherein each of the first terminal and the second terminal has a pair of end faces facing each other in a third direction orthogonal to the first direction and the second direction, and
a third insulating part is provided on the end face side of the second region among the pair of end faces.

11. The inductor according to claim 10, wherein the element body covers a part of the third insulating part.

12. The inductor according to claim 11,
wherein the element body is formed by including a magnetic material, and
a content of the magnetic material per unit volume in a portion covering the part of the third insulating part in the element body is lower than a content of the magnetic material per unit volume in other portions of the element body.

13. The inductor according to claim 1,
wherein the element body has a first main surface and a second main surface facing each other,
the second main surface is the surface on the one side in the first direction, and
the terminal is exposed from the second main surface.

14. The inductor according to claim 13,
wherein the element body has a third side surface and a fourth side surface connecting the first main surface and the second main surface, and
the terminal includes a first terminal protruding outside the element body beyond the third side surface, and a third terminal protruding outside the element body beyond the fourth side surface.

15. The inductor according to claim 14,
wherein an end face of the first terminal is exposed when viewed from the third side surface, and
an end face of the third terminal is exposed when viewed from the fourth side surface.

16. The inductor according to claim 1, further comprising a first magnetic block, a second magnetic block, and a third magnetic block disposed in the element body,
wherein the first magnetic block, the second magnetic block, and the third magnetic block are disposed spaced apart from each other in a third direction orthogonal to the first direction and a second direction orthogonal to the first direction.

17. The inductor according to claim 16, wherein the coil conductor includes a first coil conductor disposed between the first magnetic block and the second magnetic block, and a second coil conductor disposed between the second magnetic block and the third magnetic block.

18. The inductor according to claim 1, wherein each of a pair of side surfaces in a third direction orthogonal to the first direction and a second direction orthogonal to the first direction of a portion protruding beyond the element body in the terminal is covered by a part of the element body.

19. The inductor according to claim 1,
wherein a plating layer is provided on the terminal, and
the plating layer is formed on a portion exposed in the first region.

20. A DC-DC converter comprising the inductor according to claim 1.
